(19) United States
(12) Patent Application Publication
(10) Pub. No.: US 2026/0177748 A1
(43) Pub. Date: Jun. 25, 2026

(54) ON-CHIP INTEGRABLE ORDERED AND HIGHLY SPECTRALLY UNIFORM SINGLE PHOTON SOURCES FOR SCALABLE QUANTUM OPTICAL CIRCUITS

(71) Applicant: UNIVERSITY OF SOUTHERN CALIFORNIA, Los Angeles, CA (US)

(72) Inventors: Anupam MADHUKAR, Los Angeles, CA (US); Jiefei ZHANG, Los Angeles, CA (US); Swarnabha CHATTARAJ, Los Angeles, CA (US)

(73) Assignee: UNIVERSITY OF SOUTHERN CALIFORNIA, Los Angeles, CA (US)

(21) Appl. No.: 18/840,348

(22) PCT Filed: Feb. 22, 2023
(86) PCT No.: PCT/US2023/013590

§ 371 Date: Aug. 21, 2024

Related U.S. Application Data
(60) Provisional application No. 63/312,447, filed on Feb. 22, 2022.

(51) Int. Cl. G02B 6/13; G02B 6/12; G06N 10/40

(52) U.S. Cl. CPC G02B 6/131; G06N 10/40; G02B 2006/12061; G02B 2006/12078; G02B 2006/12085; G02B 2006/12104; G02B 2006/12123; G02B 2006/12178

(57) ABSTRACT

A method for fabricated on-chip quantum optical circuits is provided. The quantum optical circuit uses spatially ordered and spectrally uniform single photon sources based on a new class of epitaxial quantum dots, dubbed mesa-top single quantum dots. The large scale on-chip integration of the mesa-top single quantum dots with emitted photon manipulating units using either monolithic integration or hybrid integration with silicon photonics approaches for large scale entangled photon generation (>100-1000 photons) at high repetition rates (˜>10 GHz).

### CROSS-REFERENCE TO RELATED APPLICATIONS

This application claims the benefit of U.S. provisional application Ser. No. 63/312,447 filed Feb. 22, 2022, the disclosure of which is hereby incorporated in its entirety by reference herein.

### STATEMENT REGARDING FEDERALLY SPONSORED RESEARCH OR DEVELOPMENT

This invention was made with government support under FA9550-17-01-0353 awarded by the Air Force Office of Scientific Research, then W911NF-19-1-0025 awarded by the Army Research Office. The government has certain rights in the invention.

### TECHNICAL FIELD

In at least one aspect, the present invention relates to quantum information processing, more particularly to miniaturized on-chip photon-based quantum information processing

### BACKGROUND

The current state of art of on-chip photon-based quantum information processing systems is based on the use of heralded photon emission from spontaneous four-wave mixing as the on-chip source. However, such sources generate the needed single photons probabilistically with tradeoff between single photon purity and single photon generation rate. To ensure the needed single photon purity >95%, the photon generation efficiency has been limited to <2% hence photon generate at <1 MHz. The intrinsic characteristics of such sources poses difficulty for on-chip scalability. Exploration of alternative single photon sources (SPSs) has been pursued and color centers and self-assembled quantum dots have been extensively investigated. The color centers have low quantum efficiency (<70%) and their spatial positions as well as the number of centers per site are not well-controlled as these are controlled by the Poisson statistics of the implantation process, thus making them unsuitable for on-chip scalable integration. The more commonly explored self-assembled quantum dot, on the other hand, has 100% quantum efficiency and are capable of generating single photons at ˜>10 GHz rate. But their position on-chip is random and the spontaneous process of their formation inherently results size, shape, and composition fluctuations that give large spectral emission nonuniformity, not suitable for on-chip scalable integration either.

Accordingly, there is a need for new single source photon sources for on-chip photon-based quantum information processing.

### SUMMARY

In at least one aspect, a method for fabricated on-chip quantum optical circuits is provided. The quantum optical circuit uses spatially ordered and spectrally uniform single photon sources based on a new class of epitaxial quantum dots, dubbed mesa-top single quantum dots (MTSQDs). The large scale on-chip integration of the mesa-top single quantum dots with emitted photon manipulating units using either monolithic integration or hybrid integration with silicon photonics approaches for large scale entangled photon generation (>100-1000 photons) at high repetition rates (˜>10 GHZ).

In another aspect, a method for fabricated on-chip quantum optical circuits is provided. The method includes a step of performing substrate-encoded size-reducing epitaxy to form a plurality of mesa-top single quantum dots on a crystalline substrate and planarize the plurality of mesa-top single quantum dots such that the plurality of mesa-top single quantum dots are embedded in a semiconductor matrix. The semiconductor matrix is patterned to form waveguides including the plurality of mesa-top single quantum dots. Air cavities are formed in the semiconductor matrix. Each mesa-top single quantum dot is disposed between at least two air cavities. Such mesa-top single quantum dot-cavity structures may be interconnected with waveguides, beam splitters and beam combiners to form a quantum optical circuit.

In another method, the method for fabricated on-chip quantum optical circuits allowed the creation of planarized on-chip quantum optical circuits with on-chip integrated indistinguishable single photon source as show in FIG. 1. The on-demand single photon sources are realized using MTSQDs on pedestal shape mesa buried underneath (FIG. 1). The planarized MTSQDs structure provides the needed platform of MTSQD SPSs that are to be integrated with light control units through lithography and etching. The ability to precisely control the position of the uniformly emitting quantum dots in a planarized structure enables the production of optical circuits.

In another aspect, a quantum optical circuit fabricated by the methods described herein is provided.

In another aspect, a quantum information processing system fabricated by the methods set forth herein is provided. The quantum information processing system includes an electrical control unit; and a functional network of multiple devices that includes the plurality of mesa-top single quantum dots. The electrical control unit is in electrical or optical communication with the functional network of multiple devices containing mesa-top single quantum dots. Characteristically, during operation, the quantum information processing system is configured to receive an electrical signal from a quantum algorithm and to output extracted quantum information.

In another aspect, the quantum information processing system further includes detectors and signal amplifiers.

In another aspect, the quantum information processing system includes an electrical control unit, a functional network of multiple devices including one or more pluralities of mesa-top single quantum dots, and waveguides that include the plurality of mesa-top single quantum dots. The waveguides are composed of a patterned semiconductor matrix with each mesa-top single quantum dot disposed between at least two air cavities. Characteristically, the electrical control unit is in electrical or optical communication with the functional network of multiple devices. Advantageously, during operation, the quantum information processing system is configured to receive an electrical signal from a quantum algorithm and to output extracted quantum information.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic showing the planarized structure containing ordered arrays of spectrally uniform single photon sources based on MTSQDs.

FIG. 2. Schematic diagram showing the growth of MTSQDs via SESRE method in accordance with the present principles.

FIG. 3. Schematic showing a chip integrated device for the generation of a plural of entangled photons in accordance with the present principles.

FIG. 4. Electron microscopic image showing an exemplary array of MTSQDs made of InGaAs grown on GaAs substrate.

FIG. 5. Photoluminescence spectrum of an exemplary planarized MTSQD.

FIG. 6. Photoluminescence wavelength distribution of an exemplary array of planarized MTSQDs.

FIG. 7. Coincidence count histogram, g⁽²⁾(t), of emitted photons from a MTSQDs.

FIG. 8. Measured coincidence count histogram revealing indistinguishability of emitted photon from a MTSQDs.

FIG. 9. Block diagram showing the steps involved in the generation of a plural of entangled photons via the devices shown in FIG. 2.

FIG. 10. Schematic of the architecture of a device wherein the substrate is Si and the MTSQDs are grown on III-V or II-VI semiconductor substrate and subsequently transferred onto the Si substrate.

FIG. 11. Block diagram showing the procedure to fabricate a device as described in FIG. 10.

FIG. 12. Schematic of the architecture a device wherein the substrate is III-V or II-VI semiconductor and the MTSQDs are grown monolithically on the substrate. The etch stop layer (typically made of AlGaAs) is to be etched away to create a membrane containing the device (MTSQDs coupled to cavity, waveguide, beam splitter, phase shift and etc.).

FIG. 13. Block diagram showing the procedure to fabricate a device as described in FIG. 12.

FIG. 14. Block diagram showing a quantum computing system which employs one or more of on-chip entangled photons emitting devices as described in FIG. 2.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10.Similarly, the range 1 to 100 includes 1, 2, 3, 4.. 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For any device described herein, linear dimensions and angles can be constructed with plus or minus 50 percent of the values indicated rounded to or truncated to two significant figures of the value provided in the examples. In a refinement, linear dimensions and angles can be constructed with plus or minus 30 percent of the values indicated rounded to or truncated to two significant figures of the value provided in the examples. In another refinement, linear dimensions and angles can be constructed with plus or minus 10 percent of the values indicated rounded to or truncated to two significant figures of the value provided in the examples.

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

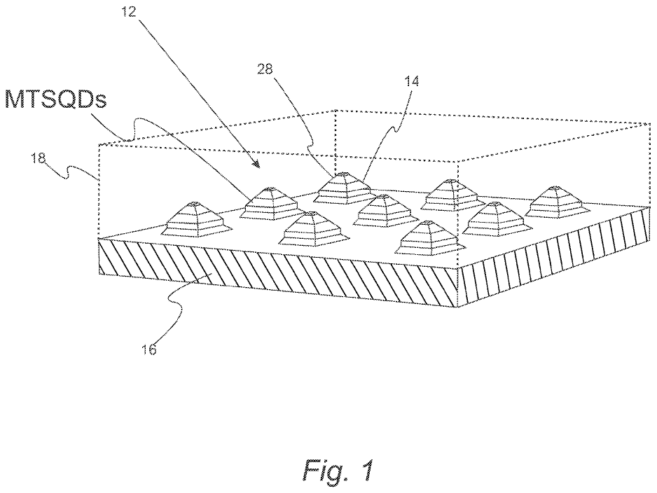

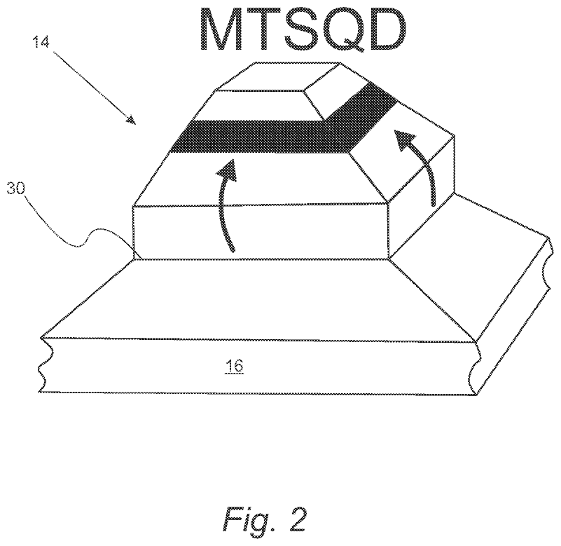

As with reference to the Figures, the same reference numerals may be used herein to refer to the same parameters and components or their similar modifications and alternatives. For purposes of description herein, the directional terms “upper,” “lower,” “right,” “left,” “rear,”“front,” “vertical,” “horizontal,” and derivatives thereof shall relate to the present disclosure as oriented in FIGS. 1 and 2. However, it is to be understood that the present disclosure may assume various alternative orientations, except where expressly specified to the contrary. It is also to be understood that the specific devices and processes illustrated in the drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. The drawings referenced herein are schematic and associated views thereof are not necessarily drawn to scale.

In a variation, the term “nanometer-sized” refers to objects having at least one dimension from 1 to 500 nm. In a refinement, the term “nanometer-sized” refers to objects having at least one dimension from 1 to 100 nm. In some refinements, the term “nanometer-sized” refers to objects having at least one dimension of at least 0.5 nm, 1 nm, 5 nm, 10 nm, 15 nm, 20 nm, or 25 nm and at least one dimension of at most 500 nm, 300 nm, 200 nm, 100 nm, 80 nm, 70 nm, or 60 nm.

The term “delta doping means” means doping a very thin region of a semiconductor layer with a very high density of dopant.

Throughout this application, where publications are referenced, the disclosures of these publications in their entireties are hereby incorporated by reference into this application to more fully describe the state of the art to which this invention pertains.

### Abbreviations

“DBR” means distributed Bragg reflector.
“MBE” means molecular beam epitaxy.
“MTSQD” means mesa-top single quantum dot.
“SAQD” means self-assembled quantum dot.
“SESRE” means substrate-encoded size-reducing epitaxy.
“SPS” means single photon source.
“SQD” means single quantum dot.
“QD” means quantum dot.

Quantum dots, with near unity quantum efficiency and intrinsic decay lifetime of ˜<1 ns, can produce the needed on-demand highly pure single photons at a high repetition rate (˜>10 GHz). The typically explored quantum dots are self-assembled quantum dots (SAQDs) that form randomly on the chip with random size and shape lacking control on spectral uniformity, making them unsuitable for on-chip integration to realize scalable optical circuits. The MTSQDs described herein can overcome all these difficulties of the SAQDs.

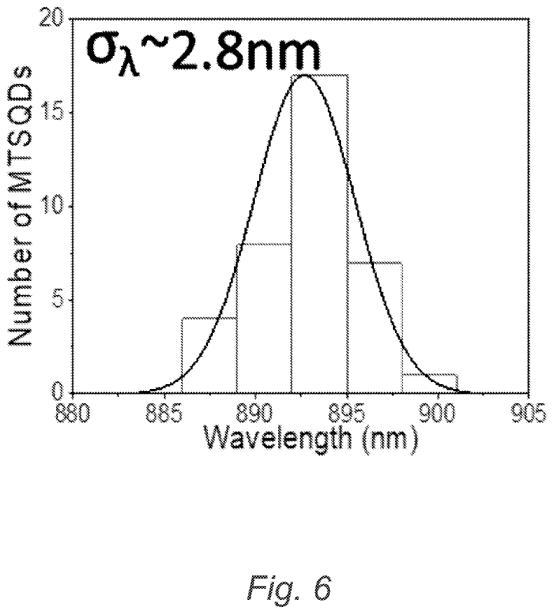

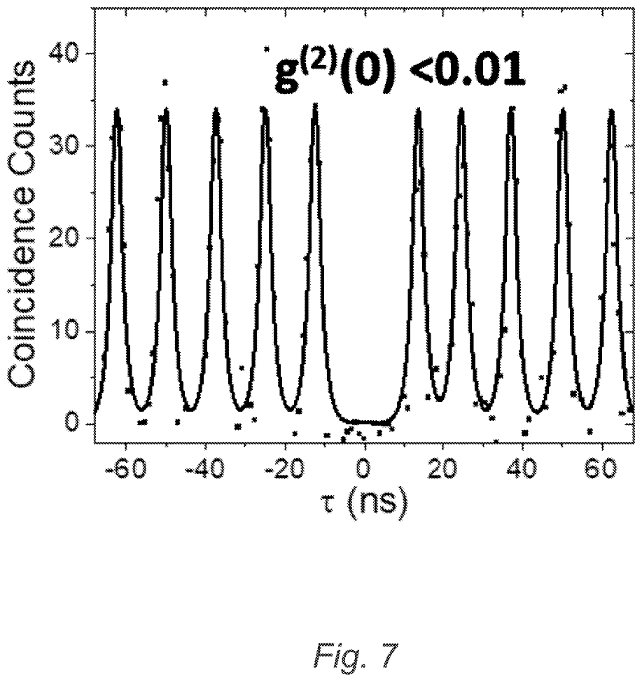

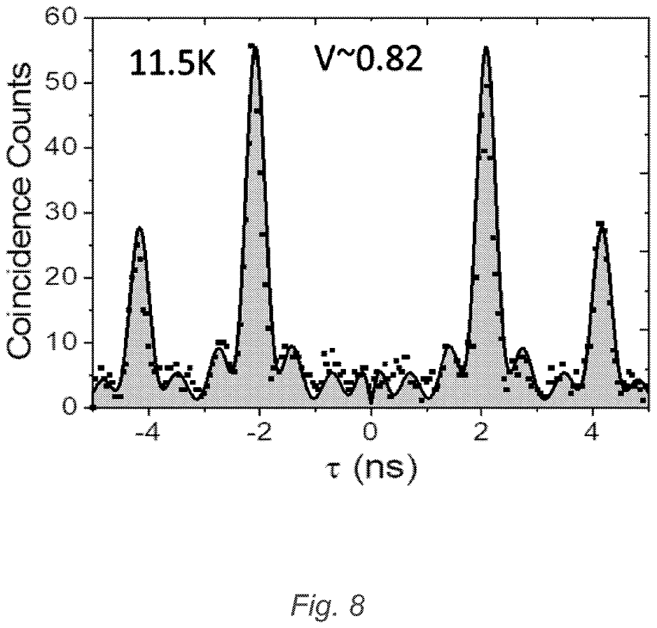

Referring to FIGS. 1 and 2, MTSQD array 10 includes a plurality 12 of mesa-top single quantum dots (SQD) 14 on a crystalline substrate 16. The SQD locations of the in MTSQD arrays 10, are controllable to within a few nm (FIG. 2) as it is synthesized using substrate-encoded size-reducing epitaxy (SESRE) that selectively directs adatom migration direction during molecular beam epitaxy (MBE) growth to the mesa top (black arrow in FIG. 2) through control of surface strain and stress distribution induced by patterned mesas on the substrate. On a starting surface with fabricated regular arrays of nanometer-sized mesas with a defined edge orientation, shape (sidewalls) and depth, the adatom migration from sidewall to mesa-top during the growth leads to the size-reducing growth on mesa. Quantum dots are then created on top of the mesas (the black region in FIG. 2) by adding appropriate atoms. Due to control on QD shape and size, the MTSQDs array (FIG. 2) shows very narrow spectral non-uniformity of <3 nm (FIG. 6). Through engineering the starting pedestal shape of mesa (FIG. 1 and FIG. 2), the MTSQDs (FIG. 1) in the GaAs matrix cam be planarized with the continued growth of GaAs after the formation of MTSQDs. Such highly spectrally uniform and ordered MTSQDs produce highly pure (with purity >99%, FIG. 7) and highly indistinguishable (˜82%, FIG. 8) single photons.

In some variations, the position and the uniformity of quantum dots can be controlled as follows: (1) The starting nanomesas are of pedestal shape for the MTSQD to form on top of the mesa; (2) The size and edge orientation of the pedestal mesa is chosen to ensure atom migration from the mesa sidewall to the top for the formation of MTSQD (3) The shape of the pedestal mesa is chosen to ensure planarizing growth after the formation of MTSQD to create buried MTSQD in a structure with flat morphology.

Even the QDs with good control of the above three are still inherently inhomogeneous in emitting wavelength of light. The issue is further complicated by the fine-structure splitting of the emission wavelength and the charge-induced spectral diffusion. Therefore, the integration of the on-chip single-photon sources into a planarized on-chip architecture requires the following innovations. The crystalline surface orientation is used to minimize fine structure splitting. In this regard, it is advantageous to control the surface orientation of the starting substrate on which pedestal mesas are to be created to control mesa top surface orientation. In other words, the mesa top surface orientation is selected to minimized fine structure splitting. For example, (111) surface orientation can be used in addition to or instead of the (001) orientation for the formation of QDs with smaller fine structure splitting. In another refinement, delta doping can be used to minimize spectral diffusion. Through the creation of a layer of material with a controlled doping level, one can compensate against the unintended doping of the grown material around MTSQD due to the incorporation of background impurities in the growth chamber. In another refinement, the emission wavelength of light of the MTSQDs can be tuned on-chip using two different methods: (1) apply local heating around the MTSQD (2) apply a local electric with MTSQDs embedded in a p-i-n structure (i.e., via the Stark effect).

In some variations, additional innovations are utilized to create quantum optical circuits. These circuits can include the waveguides, beam splitters, and phase shifters depicted herein. To a hybrid approach involving a nano-beam cavity and a novel method to transfer (e.g., flip-chip bonding or transfer printing) the MTSQDs onto silicon addresses the issue of the incompatibility of III-V or II-VI MTSQDs with silicon. To address the issues of photon leak through the substrate (typically GaAs) in the monolithic architecture, we disclose an approach of creating (1) membrane containing planarized MTSQDs to cut down photon leak to the substrate, (2) embedding a grown layer of CaF₂ or BaF₂ with low refractive index on substrate bearing planarized MTSQDs GaAs on insulator to prevent photon leaking to substrate. The combination of the above innovations enables the large-scale on-chip integration of MTSQD based single-photon sources using either hybrid or monolithic architecture, which can enable the interconnection of multiple MTSQDs to realize large-scale entangled photon generation (>10-1000 photons) at high repetition (˜>10 GHz). Such entangled photon states can be used for the multi-gate operation needed for quantum computing, multi-channel teleportation needed for quantum communication, and high quantum-limited sensing resolution with high signal to noise for quantum metrology and sensing.

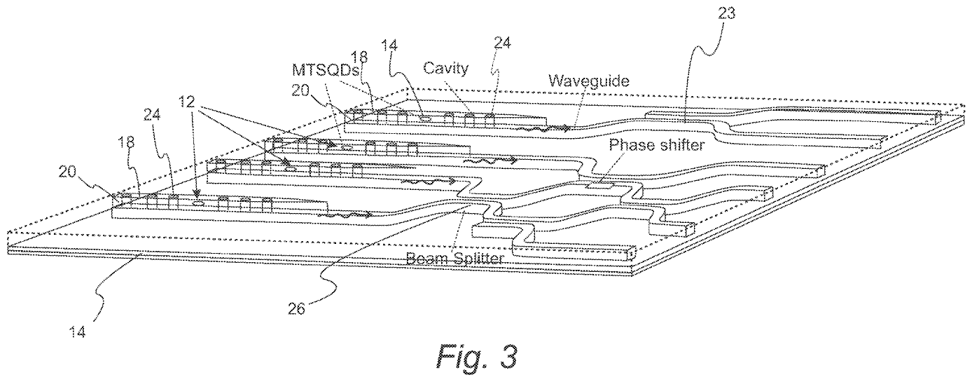

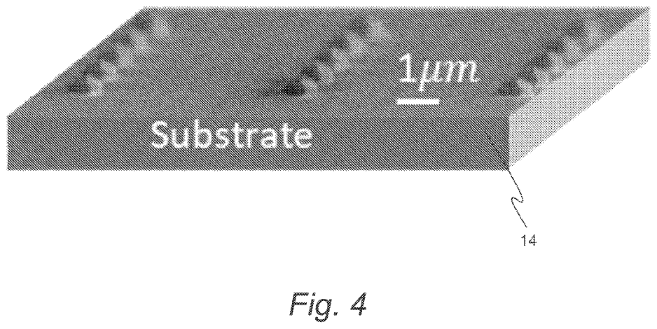

Referring to FIGS. 1-4, a method for fabricated on-chip quantum optical circuits is described. The method includes a step of performing substrate-encoded size-reducing epitaxy to form a plurality 12 of mesa-top single quantum dots 14 on a crystalline substrate 16. The plurality 12 of mesa-top single quantum dots is planarized such that the plurality of mesa-top single quantum dots is embedded in a semiconductor matrix 18. The semiconductor matrix 18 is patterned to form waveguides 20, including the plurality of mesa-top single quantum dots. Air cavities 24 are formed in the semiconductor matrix, wherein each mesa-top single quantum dots is disposed between at least two air cavities. Each mesa-top single quantum dot 14 includes a quantum dot active layer 28 interposed between non-active layers. In addition to waveguides 24, FIG. 3 also depicts beam splitter 26 in optical communication with two waveguides as well as phase shifter 27.

Characteristically, plurality 12 of mesa-top single quantum dots are formed from starting pedestal-shaped nanomesas 30 that allow mesa-top single quantum dots to form therein. Advantageously, the size and edge orientation of the pedestal-shaped nanomesas are configured to ensure atom migration from mesa sidewalls to the top of the pedestal-shaped nanomesas such that the MTSQD forms on top of the mesa. Moreover, the starting pedestal-shaped nanomesas 30 have a shape chosen to ensure planarizing growth after the formation of mesa-top single quantum dots to create buried mesa-top single quantum dots in a structure with flat morphology.

In a variation, the mesa-top single quantum dots are composed of a III-V or II-VI binary or alloy semiconductor. In a refinement, the mesa-top single quantum dots are composed of GaAs. In a variation, the quantum dot active layer is composed of doped III-V or II-VI semiconductor material. In a refinement, the quantum dot active layer are composed of silicon or beryllium doped GaAs. In another refinement, the quantum dot active layer is composed of indium-doped GaAs.

In a variation, the crystalline substrate includes a Bragg distributed reflector positioned under the plurality of mesa-top single quantum dots.

In a variation, the crystalline substrate further includes an etch stop layer interposed between the Bragg distributed reflector and the plurality of mesa-top single quantum dots. The etch stop layer may be used to create a membrane structure containing the MTSQD. The membrane structure can reduce photon leakage to the crystalline substrate.

In another aspect, the method for fabricated on-chip quantum optical circuits 1 includes a step of transferring the plurality of mesa-top single quantum dots to a silicon substrate. The silicon substrate can have circuitry formed thereon that connects the plurality of mesa-top single quantum dots. This circuitry can be formed before or after transfer. The circuity can include sections that bring photons from different mesa-top single quantum dots to generate entanglement of the photons.

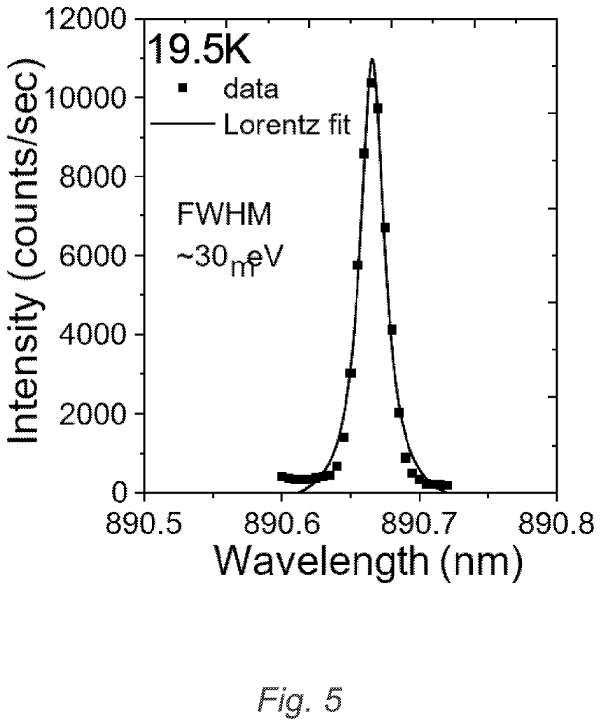

FIG. 5 provides a photoluminescence spectrum of an exemplary planarized MTSQD. FIG. 6 provides the photoluminescence wavelength distribution of an exemplary array of planarized MTSQDs. FIG. 7 provides coincidence count histogram, g⁽²⁾(τ), of emitted photons from a MTSQDs. FIG. 8 provides the measured coincidence count histogram revealing indistinguishability of emitted photon from a MTSQDs.

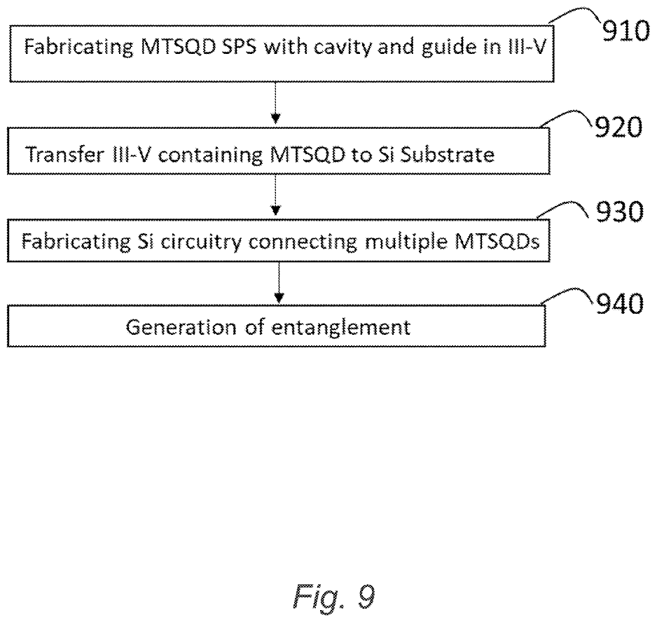

FIG. 9 provides a summary of the steps for fabricating the device of FIG. 2. In step 910, an MTSQD SPS with cavity and guide is fabricated in a III-V material. In step 920, the MTSQD is transferred to a silicon substrate. In step 930, circuitry connecting multiple MTSQDs is fabricated. In step 940, entanglement is generated by directing photons to be sufficiently close together.

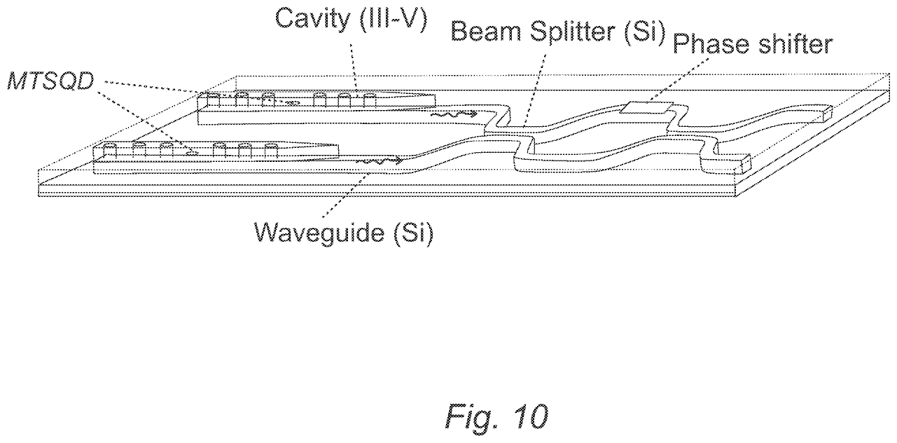

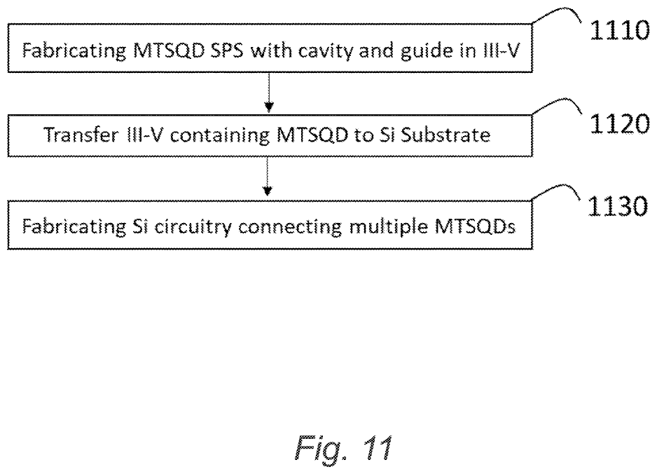

FIG. 10 provides a schematic of the architecture of a device wherein the substrate is Si and the MTSQDs are grown on III-V or II-VI semiconductor substrate and subsequently transferred onto the Si substrate. FIG. 11 provides a summary of the steps for fabricating the device of FIG. 10. In step 1110, an MTSQD SPS with cavity and guide is fabricated in a III-V material. In step 1120, the MTSQD is transferred to a silicon substrate. In step 1130, circuitry connecting multiple MTSQDs is fabricated.

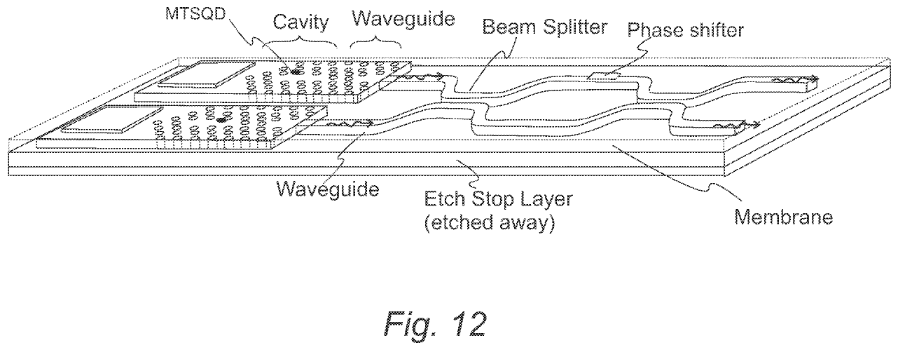

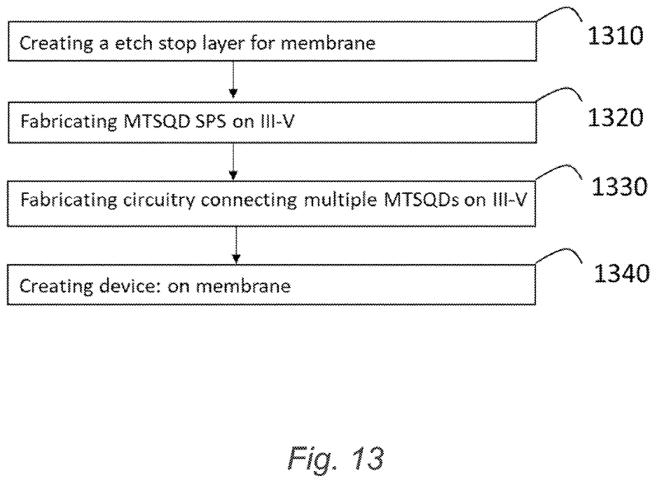

FIG. 12 provides a schematic of the architecture of a device wherein the substrate is III-V or II-VI semiconductor and the MTSQDs are grown monolithically on the substrate. The etch stop layer (typically made of AlGaAs) is to be etched away to create a membrane containing the device (MTSQDs coupled to a cavity, waveguide, beam splitter, phase shift, etc.). FIG. 13 provides a summary of the steps for fabricating the device of FIG. 12. In step 1310, an etch stop for the membrane is created. In step 1320, an MTSQS SPS is fabricated. In step 1330, circuitry connecting multiple MTSQDs is fabricated. In step 1340, a device is created on the membrane.

In another variation, a method for fabricating the devices of FIGS. 2 and 10 includes the following steps:
Creation of pedestal nanomesas on GaAs substrate
Growth of MTSQDs on pedestal mesa and subsequent planarization of MTSQDs array
Fabrication of cavity and local tapered waveguide in GaAs around MTSQDs
Transfer multiple fabricated MTSQD-cavity-waveguide structures on top of Si/SiN substrate using flip-chip bonding method or transfer printing method
Fabrication of Si waveguide and directional couplers underneath the MTSQD structures on the Si/SiN substrate.
Fabrication of phase shifters and electrical contact for on-chip tuning and control MTSQD emission wavelength.

In another variation, a method for fabricating the devices of FIG. 12 includes the following steps:
Growth of AlGaAs etch stop layer and GaAs layer on top.
Creation of pedestal nanomesas on the grown GaAs layer.
Growth of MTSQDs on pedestal mesa and subsequent planarization of MTSQDs array
Fabrication of cavity and waveguide around MTSQDs using photonic crystal approach through electron beam lithography and dry etching.
Fabrication of ridge waveguide and directional couplers connecting different MTSQDs through electron beam lithography and wet etching.
Fabrication of phase shifters and electrical contact for on-chip tuning and control MTSQD emission wavelength.
Selective etching to etch away the AlGaAs etch stop to create membrane

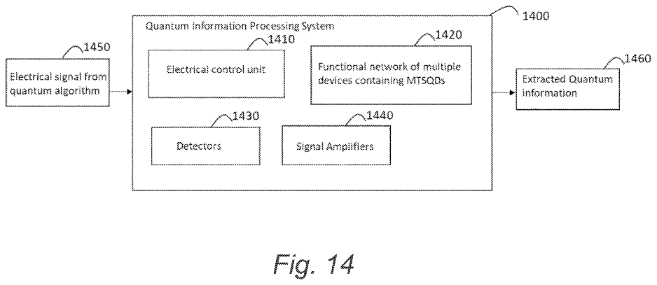

FIG. 14 provides a block diagram showing a quantum computing system which employs one or more of on-chip entangled photons emitting devices as described in FIG. 2. Quantum information processing system 1400 includes electrical control unit 1410 in electrical or optical communication with functional network 1420 of multiple devices containing MTSQDs. Quantum information processing system 1400 also includes detectors 1430 and signal amplifiers 1440. During operation quantum information processing system 1400 is configured to receive an electrical signal from a quantum algorithm (box 1450) and to output extracted quantum information (box 1460).

Referring to FIGS. 1, 2, 3, 10, 12, and 14, the quantum information processing system 1400 includes an electrical control unit 1410, a functional network 1420 of multiple devices including one or more pluralities of mesa-top single quantum dots. Waveguides 20 include the plurality of mesa-top single quantum dots. As set forth above, the waveguides 20 are composed of a patterned semiconductor matrix with each mesa-top single quantum dot disposed between at least two air cavities 24. Characteristically, the electrical control unit 1410 is in electrical or optical communication with the functional network 1420 of multiple devices. Advantageously, during operation, the quantum information processing system is configured to receive an electrical signal from a quantum algorithm and to output extracted quantum information.

Additional details for the components of the quantum information processing system 1400 are provided above. For example, the plurality of mesa-top single quantum dots can be composed of a III-V or II-VI semiconductor. In a refinement, the plurality of mesa-top single quantum dots is composed of GaAs. In another refinement, each mesa-top single quantum dot includes a quantum dot active layer interposed between non-active layers. Therefore, the quantum dot active layer can be composed of doped III-V or II-VI semiconductor material. In a refinement, the quantum dot active layer is composed of indium-doped GaAs. In a variation, the functional network includes circuitry that connects the plurality of mesa-top single quantum dots. In a refinement, the circuity includes sections that bring photons from different mesa-top single quantum dots to generate entanglement of the photons. In a variation, the plurality of mesa-top single quantum dots are disposed on a crystalline substrate. In a refinement, the crystalline substrate includes a Bragg distributed reflector positioned under the plurality of mesa-top single quantum dots. As set forth above, a mesa top surface orientation for the plurality of mesa-top single quantum dots is selected to minimized fine structure splitting. In a refinement, the mesa top surface orientation is (111) or (001).

The following examples illustrate the various embodiments of the present invention. Those skilled in the art will recognize many variations that are within the spirit of the present invention and the scope of the claims.

Sample Fabrication. The sample studied here contains a buried 5×8 array of MTSQDs sitting on top of a DBR mirror where the DBR is designed to enhance the photon collection efficiency. The DBR mirror is grown with 17 pair of GaAs (65.6 nm) and AlAs (78.3 nm) at 600° C. with TGaAs=2 sec/ML, TAIAs=2 sec/ML and PAs=3×10⁻⁶ torr. Nanomesas of size ˜300 nm with a pedestal shape are created with electron beam lithography and wet chemical etching on the GaAs layer on top of the grown DBR mirror. After growth of 271 ML GaAs under condition with τ_{GaAs}=4 sec/ML P_{As}=1.5×10⁻⁶ torr at 600° C., the mesa top opening size is reduced from ˜300 nm to ˜20 nm during the size-reducing growth on mesa resulting from the surface-curvature induced adatom migration to mesa top. To form a MTSQD on the size-reduced mesa top, 4.25 ML In_{0.5}Ga_{0.5}As is deposited at 520° C. A subsequent 1346 ML GaAs is grown to cap the QD, and to convert the surface morphology from pinched mesas to near flat surface (20) and have the QD located at the antinodes of the DBR/Air structure, ˜280 nm away from the DBR/Air interface.

Additional details for forming Mesa-top quantum dot single photon arrays are found in Jiefei Zhang, et al., Mesa-top quantum dot single photon emitter arrays: growth, optical characteristics, and the simulated optical response of integrated dielectric nanoantenna-waveguide systems, arXiv:1609.00068v2 [physics. optics]; the entire disclosure of which is hereby incorporated by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A method for fabricated on-chip quantum optical circuits comprising:
a) performing substrate-encoded size-reducing epitaxy to;
form a plurality of mesa-top single quantum dots on a crystalline substrate;
planarize the plurality of mesa-top single quantum dots such that the plurality of mesa-top single quantum dots are embedded in a semiconductor matrix;
b) patterning the semiconductor matrix to form waveguides including the plurality of mesa-top single quantum dots; and
c) forming air cavities in the semiconductor matrix, wherein each mesa-top single quantum dot is disposed between at least two air cavities.

2. The method of claim 1, wherein the plurality of mesa-top single quantum dots is composed of a III-V or II-VI semiconductor.

3. The method of claim 2, wherein the plurality of mesa-top single quantum dots is composed of GaAs.

4. The method of claim 1, wherein the plurality of mesa-top single quantum dots are formed from starting pedestal-shaped nanomesas that allow mesa-top single quantum dots to form therein.

5. The method of claim 4, wherein each mesa-top single quantum dot includes a quantum dot active layer interposed between non-active layers.

6. The method of claim 5, wherein size and edge orientation of the pedestal-shaped nanomesas is configured to ensure atom migration from mesa sidewalls to the top of the pedestal-shaped nanomesas.

7. The method of claim 6, wherein the pedestal-shaped nanomesas has a shape chosen to ensure planarizing growth after formation of mesa-top single quantum dots to create buried mesa-top single quantum dots in a structure with flat morphology.

8. The method of claim 6, wherein the quantum dot active layer is composed of doped III-V or II-VI semiconductor material.

9. The method of claim 6, wherein the quantum dot active layer is composed of indium-doped GaAs.

10. The method of claim 1 further comprising transferring the plurality of mesa-top single quantum dots to a silicon substrate, the silicon substrate having circuitry formed thereon that connects the plurality of mesa-top single quantum dots.

11. The method of claim 10, wherein the circuity includes sections that bring photons from different mesa-top single quantum dots to generate entanglement of the photons.

12. The method of claim 1, wherein the crystalline substrate includes a Bragg distributed reflector positioned under the plurality of mesa-top single quantum dots.

13. The method of claim 12, wherein the crystalline substrate further includes an etch stop layer interposed between the Bragg distributed reflector and the plurality of mesa-top single quantum dots for creation of a membrane that reduces photon leakage to the crystalline substrate.

14. The method of claim 1, wherein a mesa top surface orientation is selected to minimized fine structure splitting.

15. The method of claim 14, wherein the mesa top surface orientation is (111) or (001).

16. The method of claim 14, wherein delta doping is applied to minimize spectral diffusion.

17. The method of claim 16, wherein a wavelength of light emitted from the mesa-top single quantum dots is fined tuned.

18. The method of claim 17, wherein the wavelength of the mesa-top single quantum dots is fined tuned by applying local heating around the mesa-top single quantum dots.

19. The method of claim 17, wherein the wavelength of the mesa-top single quantum dots is fined tuned by applying a local electric with the mesa-top single quantum dots. embedded in a p-i-n structure.

20. A quantum information processing system fabricated by the method of claim 1, the quantum information processing system comprising:
an electrical control unit; and
a functional network of multiple devices including the plurality of mesa-top single quantum dots, the electrical control unit being in electrical or optical communication with the functional network of multiple devices that includes the plurality mesa-top single quantum dots, wherein during operation quantum information processing system is configured to receive an electrical signal from a quantum algorithm and to output extracted quantum information.

21. The quantum information processing system of claim 20 further comprising detectors and signal amplifiers.

22. A quantum information processing system comprising:
an electrical control unit; and
a functional network of multiple devices including a plurality of mesa-top single quantum dots; and
waveguides including the plurality of mesa-top single quantum dots, the waveguides composed of a patterned semiconductor matrix, each mesa-top single quantum dot is disposed between at least two air cavities, wherein the electrical control unit is in electrical or optical communication with the functional network of multiple devices, wherein during operation quantum information processing system is configured to receive an electrical signal from a quantum algorithm and to output extracted quantum information.

23. The quantum information processing system of claim 22, wherein the plurality of mesa-top single quantum dots is composed of a III-V or II-VI semiconductor.

24. The quantum information processing system of claim 23, wherein the plurality of mesa-top single quantum dots is composed of GaAs.

25. The quantum information processing system of claim 22, wherein each mesa-top single quantum dot includes a quantum dot active layer interposed between non-active layers.

26. The quantum information processing system of claim 25, wherein the quantum dot active layer is composed of doped III-V or II-VI semiconductor material.

27. The quantum information processing system of claim 25, wherein the quantum dot active layer is composed of indium-doped GaAs.

28. The quantum information processing system of claim 22, wherein the functional network includes circuitry that connects the plurality of mesa-top single quantum dots.

29. The quantum information processing system of claim 28, wherein the circuity includes sections that bring photons from different mesa-top single quantum dots to generate entanglement of the photons.

30. The quantum information processing system of claim 22, wherein the plurality of mesa-top single quantum dots are disposed on a crystalline substrate.

31. The quantum information processing system of claim 30, wherein the crystalline substrate includes a Bragg distributed reflector positioned under the plurality of mesa-top single quantum dots.

32. The quantum information processing system of claim 30, wherein a mesa top surface orientation for the plurality of mesa-top single quantum dots is selected to minimized fine structure splitting.

33. The quantum information processing system of claim 32, wherein the mesa top surface orientation is (111) or (001).
